(19) United States
(12) Patent Application Publication
(10) Pub. No.: US 2009/0055731 A1
(43) Pub. Date: Feb. 26, 2009

(54) Homonym words dictionary

(76) Inventor: Joyce Etta Knowles, San Antonio, TX (US)

Correspondence Address: Joyce E. Knowles, 9507 Shetland Ct, San Antonio, TX, 78254, US

(21) Appl. No.: 11/895,397

(22) Filed: Aug. 24, 2007

(51) Int. Cl. G06F 15/00

(52) U.S. Cl. 715/257

(57) ABSTRACT

Homonym Words Dictionary is a software program that scans a text document for improper word choice and usage after it has been spell checked. The most fatal shortcoming inherent in all spell checkers is allowing an improperly used but correctly spelled word to pass undetected as proper English during the spell check process. The sentence

Dew knot bee scene at the fare.
would be viewed as correct by any spell checker currently on the market. Homonym Words Dictionary however, upon encountering the same sentence, would prompt the user to type the following sentence:
Do not be seen at the fair.

A product with such capability is sorely needed and only Homonym Words Dictionary meets this need, thus making it a new and unique invention.

### A DETAILED DESCRIPTION OF THE INVENTION

Homonym Words Dictionary is a computer software program that is designed to verify proper word choice and usage in a text document. Since homophones (one of two or more words pronounced alike but different in meaning or derivation or spelling (such as do, due, and dew, our and hour, they're and there etc.)) and words whose meanings change by the addition or deletion of a double consonant (such as super and supper, diner and dinner, later and latter, sniper and snipper, etc.) are among the words presenting the greatest challenge to proper word choice. Homonym Words Dictionary, while not limiting itself to such words, specifically targets them and assists the writer in verifying correct word choice each time such words are used in a text document.

Homonym Words Dictionary accomplishes this by comparing each word in the text document with the words in its own internal dictionary/database. Each time a match is found, the corresponding word will be selected in the text document for further analysis. Homonym Words Dictionary's library and internal dictionary/database contain the most up-to-date listing of homophones and other challenging words in the English language available at the moment of the most recent release of the program. It also contains a very comprehensive listing of words that employ double consonants in their spellings.

The need for such a program as Homonym Words Dictionary is illustrated by the following sentence:
We had sum wine with hour super.

The very best of spell checkers would inform the user that the spell check is complete and that no errors were found. While all words are spelled correctly, this sentence demonstrates the use of two incorrect homophones (“sum” and “hour”) and an incorrect “double consonant” word (“super”, instead of “supper”). Homonym Words Dictionary would prompt our writer to type the following corrected sentence:
We had some wine with our supper.

This inability to monitor proper word choice is the most fatal shortcoming inherent in all spell checkers on the market today. Homonym Words Dictionary goes the necessary step beyond the spell checker's limited ability and produces a document that is not only properly spelled throughout but, more importantly, conveys the proper and intended meaning by ensuring proper word choice and usage.

The function of searching a database for words that match those found in a text document and then noting those words is a process that is understood by anyone familiar with the technology and field of knowledge required to create “find” and “find next” computer search routines.

Each word in Homonym Words Dictionary's dictionary is linked with its own particular definition which is highlighted in the text that is being proofed for proper word choice. Highlighting and point and click menus are among the most common “tools” in today's computer based spread sheet and word processing programs. The creation, function, and use of these tools is understood by those knowledgeable in the technologies and computer code required to activate these tools in any given program.

For example, upon encountering the word “there” in a text document that has been spell checked, Homonym Words Dictionary would verify that the word is in its dictionary/database (the “find” and “find next” routine) and then highlight the word and display a menu similar to the following display:

there: a location or place (over there)
their: to show possession (their car)
they're: a contraction meaning, “they are”

After reviewing the list, the user would click on the defined word that best conveys her intended meaning in the sentence being proofed and Homonym Words Dictionary will insert the selected word into the text replacing the incorrectly used word. The result is a sentence that not only has all its words spelled correctly, but one that also grammatically conveys the intended thought due to proper word choice and usage.

As can be noted in the above sample homophone definition display, not all-possible detailed definitions are presented to the user. Instead the definitions that are given are very brief but explicit enough to clearly show a definite difference in meaning thus making it easy for the user to select the proper word to convey the correct meaning.

Thus while the concept of Homonym Words Dictionary is quite simple, the actual function of the program is extremely powerful and effective in producing documents that go beyond the ability of today's spell checkers and therefore takes word processing to much higher and unprecedented level of accuracy.

Homonym Words Dictionary is also fully adaptable to the skill level and expertise of the user, offering a “Restricted” and “Unrestricted Mode”. The Unrestricted Mode is the default mode of the program and functions as described above. Homonym Words Dictionary also functions In the Restricted Mode, which allows the user to remove any homophones of her choice from the search and highlight function of the program. This mode allows the person with an above average command of the English language to be able to proof a document more quickly by having fewer highlighted words to verify. Such a user for example might “turn off” the word “to” from the search routine, feeling that she does not need assistance with the proper use of “to”, “too”, and “two”. Logically the user would turn off a word only when she has mastered the homophone usage associated with that word.

All removed words are stored in a special file. These words would be the ones removed from the search routine each time the Restricted Mode is invoked. Over time this list will become larger and larger as new words are added. The result is that the program will work at a faster speed commensurate with the skill level of the user while at the same time improving the user's ability to choose the proper word for a given sentence. Homonym Words Dictionary is thus an excellent teaching tool for students and professionals alike.

Word selection and removal as described here is a simple task and easily understood by anyone familiar with writing code for today's computers using any of the computer language writing tools readily available in today's market.

No other product on the market today addresses the particular issue of proper word choice and usage, as does Homonym Words Dictionary thus making Homonym Words Dictionary a new and unique product on the market.

1. Claim is laid to a process whereby a spell checked document is analyzed for proper homonym word choice and usage. This is accomplished by:
1) Creating a library/database of homophones and words whose definitions change by adding or deleting a double consonant along with other words that are often misused in the spoken and written language.
2) Developing a procedure for comparing text input by the user with the contents of the said library/database and alerting the user of the results of the comparison.
3) Displaying definitions of words input by the user as found in the library/database from which the user can choose a particular defined word for insertion into the text document being proofed for proper word choice and usage.
It should be understood that the composite process described above, as it applies to Homonym Words Dictionary, can be modified by one knowledgeable in a pertinent field in order to obtain sought after results in several other fields including, but not limited to, a method of verifying proper homonym choice and usage. Therefore claim is made as to the integration of any Homonym Words Dictionary process described herein in products of any type other than the Homonym Words Dictionary software system.
